(19) United States
(12) Patent Application Publication
(10) Pub. No.: US 2011/0011728 A1
(43) Pub. Date: Jan. 20, 2011

(54) System and method for conversion of molecular weights of fluids

(76) Inventors: William M. Sackinger, Fairbanks, AK (US); Halim Hamid Redhwi, Dharan (SA); Abdullah M. Aitani, North Khobar (SA); Mohammad Ashraf Ali, Dhahran (SA)

Correspondence Address: LITMAN LAW OFFICES, LTD., PATENT LAW BUILDING, 8955 CENTER STREET, MANASSAS, VA, 20110, US

(21) Appl. No.: 12/458,551

(22) Filed: Jul. 15, 2009

(51) Int. Cl. C10G 15/08; B01J 19/12; B01J 19/08; G05D 23/00

(52) U.S. Cl. 204/155; 204/172; 204/559; 422/186.04; 422/186.03; 422/105

(57) ABSTRACT

The system and method for conversion of molecular weights of fluids includes an elongate metallic pipe. A fluid is caused to flow through the pipe. A center electrode is mounted within the pipe coaxially with the pipe axis and the flow direction, the electrode being insulated from the pipe wall. The center electrode and the pipe wall are connected to the terminals of a voltage source to create an electric field extending radially between the center electrode and the pipe wall. A source of gamma radiation positioned either within the center electrode or external to the pipe directs gamma rays transverse to the direction of fluid flow. The combined radiation and electric field disrupts chemical bonds, creating ionization zones and resulting in the formation of lower-molecular-weight compounds. Optionally, a magnetic field may be superimposed in the direction of fluid flow.

### BACKGROUND OF THE INVENTION

1. Field of the Invention

The present invention relates to apparatus and methods for the cracking or reformation of fluids, and particularly to a system and method for conversion of molecular weights of fluids. As it is applied to hydrocarbon-containing fluids, the system and method increases the value of petroleum through the removal of impurities, and the non-catalytic reforming of high-molecular-weight hydrocarbons to lower-molecular-weight compounds having greater economic value. As the system and method of the present invention are applied to fluorocarbons, silicone fluids, and similar stable compounds, the system and method create a spectrum of new compounds, some which have greater economic value.

2. Description of the Related Art

In relation to the production and processing of crude oil and of refined petroleum products, it is often desirable to increase the value, both in terms of monetary value and in terms of essential resources, of a liquid stream of mixed hydrocarbon molecules. For example, it is desirable to remove sulfur and heavy-metal compounds from the liquid stream, and, in some cases, to convert large hydrocarbon molecules into smaller hydrocarbon molecules, which are more useful as fuels and petrochemical feed stocks.

It may be further desirable to convert aromatic hydrocarbons into alkanes and olefins. Although catalytic methods are available to a limited extent for such purposes, these methods involve costs for catalyst replacement and have limitations with regard to operating temperatures, pressures, flow rates and the types of chemical transformations that can be accomplished. For example, sulfur and sulfur compounds have been removed by catalytic contact decomposition by nickel, natural silicates, bauxite, or alumina, by cracking followed by reduction or hydrogenation, or by reaction with various chemical absorbents. Furthermore, the process of thermolytic cracking and catalytic reformation to improve the octane rating of gasoline is well known.

Although electrical methods for the conversion of molecular weights using plasma processes have been described or proposed for gases, and for mixtures of gases and particulates, such methods are not generally available for application to hydrocarbon liquids at normal temperatures and pressures. For example, an article presented to the Diesel Engine Emission Reduction Workshop in August-September 2004 by Bromberg et al. described MIT's efforts to develop a “plasmatron” fuel reformer for the on-board production of hydrogen-rich gas in vehicles, e.g., for hydrogen fuel cells, from hydrocarbon feedstocks, such as petroleum products, ethanol, and vegetable oils. The plasmatron uses a flowing air/fuel mixture that encounters a plasma discharge of several thousand volts, with currents of hundreds of milliamperes. The plasma region is followed by a homogenous reactor where products are formed at about 1,000° C. A catalyst may optionally be used to increase the output of hydrogen gas. However, it appears that the plasmatron converter is still in development and not ready for practical implementation in production vehicles.

None of the above inventions, taken either singly or in combination, is seen to describe the instant invention as claimed. Thus, a system and method for conversion of molecular weights of fluids solving the aforementioned problems is desired.

### SUMMARY OF THE INVENTION

The system and method for conversion of molecular weights of fluids provides an apparatus and method for reducing the average molecular weight of a liquid, such as, for example, a petroleum-based fluid mixture, through application of an electrical field and a source of ionizing radiation, such as gamma radiation. The system includes an elongate metallic pipe, which may have any cross-sectional shape. In this exemplary application, a hydrocarbon liquid is caused to flow through the pipe. A center electrode is mounted within the pipe coaxially with the pipe axis and the flow direction, the electrode being insulated from the pipe wall. The center electrode and the pipe wall are connected to the terminals of a voltage source to create an electric field extending radially between the center electrode and the pipe wall. A source of gamma radiation positioned either within the center electrode or external to the pipe directs gamma rays transverse to the direction of fluid flow. The combined radiation and electric field disrupts carbon-sulfur, carbon-hydrogen, and carbon-carbon bonds, creating ionization zones and resulting in the formation of lower-molecular-weight compounds.

The ionization zones will include both free electrons and positive ions. The applied electric field may be a pulsed source of very high voltage, so that the electron flow is accelerated, causing high-impact collisions with neutral molecules, further accelerating the ionization of the fluid. The system may be enhanced by superimposing a magnetic field in the axial flow direction, so that the electrons and positive ions move in crossed electric and magnetic fields. The result of the ionization reactions will generally be lower-molecular-weight compounds, although some larger-molecular-weight compounds will also be formed.

Further, the ionization and energization of the fluid mixture increase the temperature of the fluid. A heat exchanger may be further provided for removing thermal energy from the fluid for use elsewhere within the system, or for powering external components.

In a preferred embodiment of the present system, the reactor pipe is disposed vertically. Feedstock enters at the bottom of the reactor pipe and is caused to flow upward. The feedstock may be a hydrocarbon liquid or emulsion, and may include gases that are dissolved in the liquid or that are present as bubbles as a two-phase system, and may also include entrained particulates that are extremely small or fine particles. As the feedstock rises in the reactor pipe, it is subjected to the gamma radiation and the electric field, and optionally the magnetic field, generating a plasma that converts the molecular weights of the compounds in the feedstock, generally to lower-molecular-weight compounds. The more volatile compounds form gases that bubble upward in the reactor pipe and increase flow velocity.

The flow is directed through a gas/liquid separator at the upper end of the reactor pipe. Gaseous output exits through an outlet conduit at the upper end of the reactor pipe and may be directed through a condenser or other processing apparatus for collection of the compounds of interest. The remaining liquid or heavier-weight compounds are directed through a feedback or reflux pipe to mix with fresh feedstock and re-enter the bottom of the reactor pipe. Optionally, either all or a portion of the recycled feedstock may be diverted from the feedback pipe for alternative processing.

These and other features of the present invention will become readily apparent upon further review of the following specification and drawings.

### BRIEF DESCRIPTION OF THE DRAWINGS

FIG. 1 is a diagrammatic side view of a system for conversion of molecular weights of fluids according to the present invention.

FIG. 2 is a diagrammatic view in axial section of the system for conversion of molecular weights of fluids according to the present invention, showing the orientation of the applied electric and magnetic fields and the applied gamma radiation.

FIG. 3 is a diagrammatic side view of an alternative embodiment of the system for conversion of molecular weights of fluids according to the present invention.

Similar reference characters denote corresponding features consistently throughout the attached drawings.

### DETAILED DESCRIPTION OF THE PREFERRED EMBODIMENTS

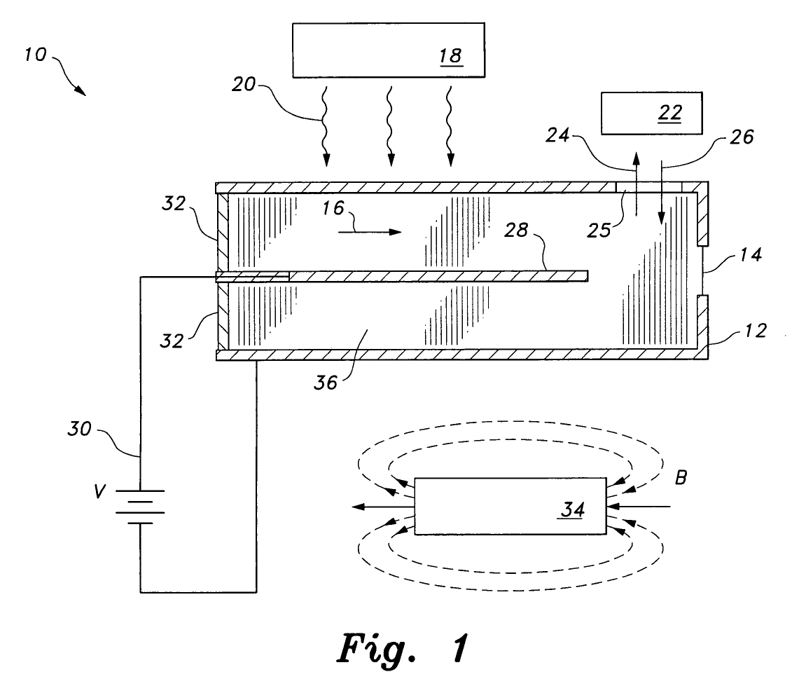

As illustrated in FIG. 1, a first embodiment of the system 10 for the conversion of molecular weights of fluids includes an elongated metallic pipe 12. The pipe 12 may have a closed end with an optically transparent window 14, allowing the user to view the chemical reactions, both for observational and analysis purposes, the fluid entering and exiting the pipe 12 through transversely extending inlet and outlet pipes (not shown) at opposite ends of the pipe 12. Alternatively, fluid may enter and exit the pipe 12 through coaxial inlet and outlet ports, with the observation window being disposed laterally in the wall of the pipe 12. Fluid flows through the reaction chamber 36 defined by pipe 12 in the flow direction indicated by directional arrow 16.

The fluid is a liquid mixture of hydrocarbons, e.g., a petroleum product, such as crude oil, kerosene, diesel oil, etc. Alternatively, the fluid may be ethanol, vegetable oil, or any other mixture that it is desired to reform into products of different molecular weight. The fluid may include gases dissolved in liquid, or bubbles of gases suspended or entrained in the liquid in a two-phase gas/liquid system. The fluid may also include extremely small or fine solid phase particles, e.g., polymers of interest, entrained in liquid. The fluid may be forced into housing, along path 16, through any suitable method, such as by use of a pressurizing pump, and the products may be extracted by any suitable method.

Although center electrode 28 is shown as a cylindrical pipe in the drawings, pipe 12 may have any desired cross-sectional contour, e.g., square or rectangular tubing. A center electrode 28 extends coaxially within the chamber 36 defined by pipe 12 in the fluid flow direction 16, and is isolated from the wall of the pipe 12 by insulators 32. Although center electrode 28 is shown concentrically mounted within pipe 12 in the drawings, it will be understood that the scope of the present invention extends to an electrode 28 mounted eccentrically within pipe 12 but extending coaxially in the flow direction 16.

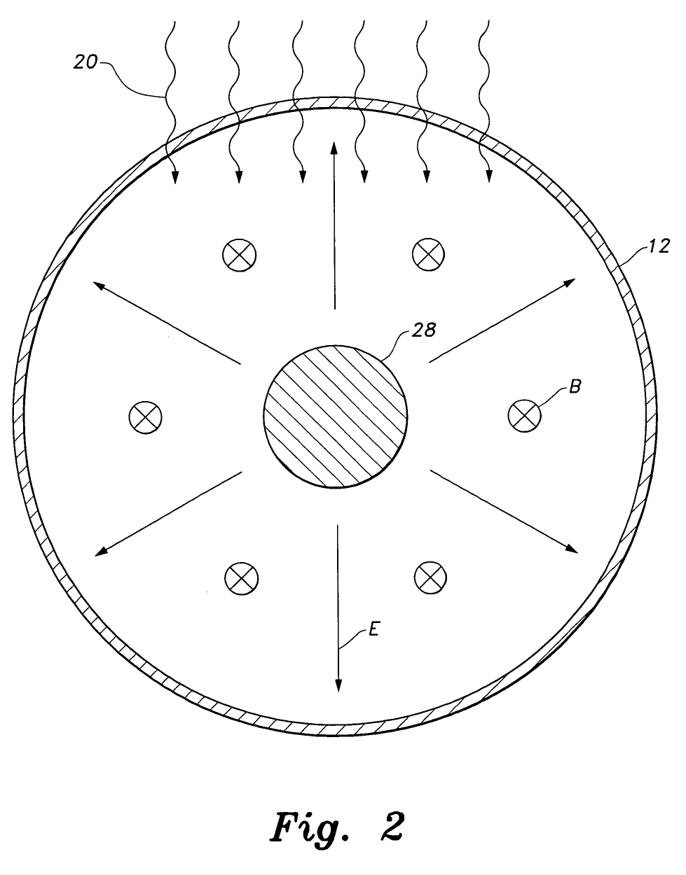

The wall of pipe 12 and the center electrode 28 are connected to an external voltage supply V to generate an electric field E, which extends in a substantially-radial direction, as shown in FIG. 2. A source of ionizing radiation 18 is provided for generating ionizing radiation 20, which is transmitted into reaction chamber 36. The ionizing radiation 20 is preferably gamma radiation. The radiation source 18 may be positioned external to pipe 12, as shown, or, alternatively, may be located within electrode 28. When fluid flows within pipe 12, the ionizing radiation 20 creates a multiplicity of ionization events within the fluid. Preferably, fluid continuously flows through pipe 12 so that the creation of ionized channels within the fluid is continuous, within reaction chamber 36.

The ionization events within the fluid involve the destruction of the chemical bonds within the molecules forming the fluid. In a mixed hydrocarbon fluid, this destruction may include, for example, the disruption of carbon-sulfur bonds, carbon-hydrogen bonds, and carbon-carbon bonds. Additionally, free electrons and positive ions are created during the ionization events, as well as ions and molecules being energized to their excited states. Decay of these excited states results in the emission of photons and, to a lesser extent, the subsequent emission of further electrons. The generation of charged particles within the fluid, both in the form of free electrons and new positive ions, results in new chemical reactions and in the formation of new molecules.

The chemical activity of the ionized fluid is enhanced by the presence of the electrical field E, induced by voltage source V. The voltage source V is, preferably, a relatively-high-voltage source so that the free electrons are accelerated by electric field E, preferably acquiring several electron volts of energy, so that the electrons will collide with adjacent neutral molecules, generating further ionization events. Additional electrons will be created by these secondary ionization events, which, in turn, are also accelerated by the electric field E, creating further ionization events. This cascading ionization process results in the creation of new chemical reactions, the emission of photons in a wide spectrum of wavelengths, and in other energetic processes within the fluid. Voltage source V is connected to pipe 12 and electrode 28 via conductors 30.

This ionization and energization of the fluid enhances the decomposition of the molecules that were initially ionized by radiation 20, which results in the recombination of these ions with other molecules present in the fluid, such as oxygen, nitrogen, hydrogen, argon and water, which may be present if there is air dissolved in the fluid. The newly-formed molecules will generally have a smaller molecular weight than the original molecules found within the fluid, though some larger weight molecules will be created. The average molecular weight of the fluid, however, will be decreased by the ionization process.

The energy added to the fluid by radiation 20 and electric field E produces chemical conversions, photons and heat. As the fluid temperature increases, the production of new active zones within the fluid and the rate of ionization will increase, thus increasing the rate of chemical conversion activity. Once the fluid has passed through pipe 12 for a time and length sufficient to generate desired new molecules, a heat exchanger 22 may extract thermal energy from the fluid for any desired usage.

Heat exchanger 22 may be positioned within the fluid path, or may be positioned external to pipe 12, as shown in FIG. 1. In this embodiment, a port 25 is formed through pipe 12 through which the heated fluid exits pipe 12 (represented by directional arrow 24), and the newly cooled fluid is re-inputted to pipe 12 back through port 25 (represented by directional arrow 26).

As a further alternative, a fluid feedback loop may be added so that fluid exiting the pipe 12 is fed back into pipe 12 for the creation of a fluid having an even smaller average molecular weight.

Voltage V may be either continuous or pulsed. However, in the preferred embodiment, voltage source V provides a pulsed voltage. The electrical effect on the ionization activity only takes place when the voltage source is “on” during the pulsed cycle.

Additionally, a magnet 34, such as a ferromagnet, an electromagnet or the like, may be provided for generating a magnetic field B. The magnet 34 is arranged so that magnetic field B, as shown in FIG. 2, travels along a direction substantially parallel to fluid flow 16 within reaction chamber 36. Magnetic field B allows for the confinement of ion motion to smaller regions within the ionization zones, thus providing a larger number of collisions between ions and neutral molecules within the zones.

The preferable orthogonal arrangement between electric field E and magnetic field B within chamber 36 will generate cycloidal motion in the charged particles, although no net energy is transferred to the charged particles by the magnetic field unless the strength of the magnetic field is time-variable. Magnetic field B may be static, thus creating a change in direction only of the motion of the particles, rather than an increase in kinetic energy. With the particles moving in a substantially circumferential direction, a higher probability of collision with neutral particles is generated.

The energy acquired by a charged particle between the creation of that charged particle, via ionization, and the collision of the charged particle with a neutral molecule is preferably greater than the ionization energy of the neutral molecule. The mean free path of the charged particles as they move in a quarter-cycloid trajectory is, statistically, of the same order as the mean free path for their collision with a neutral molecule. Voltage V may be user selectable, allowing for the adjustment to accomplish such collisions.

With the application of the crossed electric and magnetic fields, a greater number of collisions and, thus, a greater number of molecular conversions, is achieved. The plasma existing within the active zones grows by the cascade process described above during the period that the pulsed voltage V is applied, after which the recombination of ions and electrons will take place.

Although current will be induced in conductors 30 during the time of movement of charges, the actual arrival of charges at the boundary electrodes 12, 28 will provide a minimal effect during operation of system 10. In the example of the removal of sulfur atoms from their bonds in large aromatic hydrocarbon molecules, this ionic activity, which also includes the creation of hydrogen ions, will not only disbond the sulfur, but will also lead to the production of hydrogen sulfide gas, which dissolves in the liquid. The dissolved hydrogen sulfide gas may be removed from the output stream through conventional methods, thus resulting in lower sulfur content in the fluid following the conversion process of system 10.

As described above, the liquid stream feeding system 10 may be a mixture of hydrocarbons or may be an emulsified mixture of two or more liquids, which are intended for the conversion process described above. In addition, suitable gases may also be dissolved in the liquid stream if the user desires gas/liquid reactions to take place in the plasma or near plasma conditions within system 10.

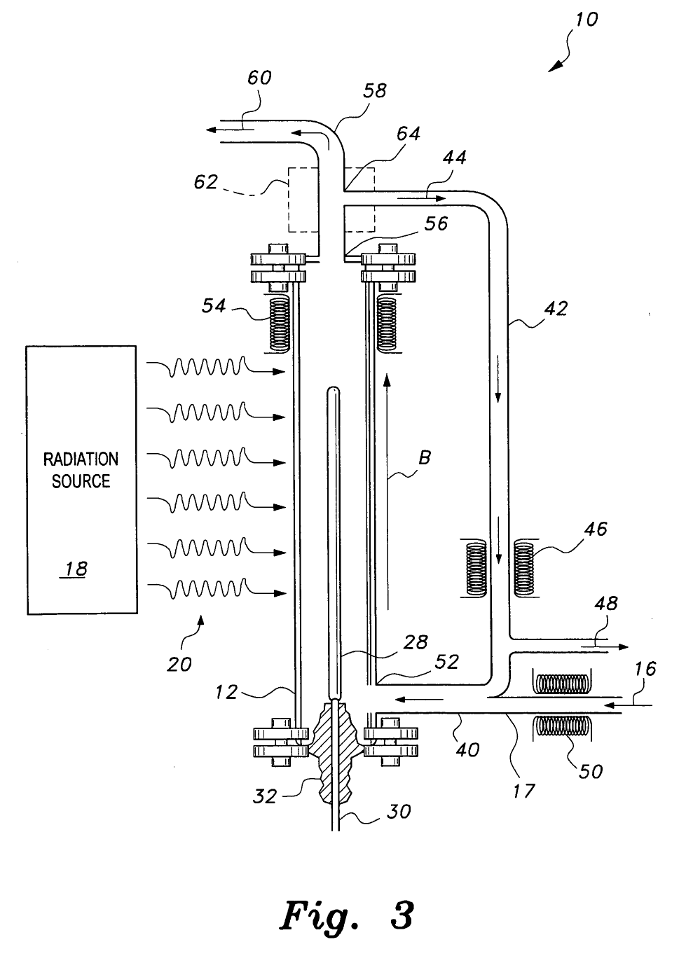

In the embodiment of FIG. 3, the pipe 12 is positioned vertically. The lower end of the pipe 12 is sealed with the high voltage insulation 32, which covers conductor 30. An opening 52 is formed through a sidewall of pipe 12, adjacent to the lower end for inputting the fluid mixture through inlet pipe 17, as indicated by directional arrow 16. In the embodiment of FIG. 3, the fluid optionally may be pre-heated prior to entry within pipe 12 by a heating element 50. The addition of thermal energy to the fluid will increase collisions between molecules, thus increasing the rate and number of chemical reactions within the fluid during the ionization and energization process.

An opening 56 is formed through the upper end of pipe 12 for egress of the fluid from the pipe 12 following the application of radiation 20, electric field E and magnetic field B, as described above with reference to FIGS. 1 and 2. An outlet pipe 58 is mounted on the upper end of pipe 12 and receives the fluid flowing through opening 56. As the fluid temperature increases, lower-molecular-weight molecules are produced, some of which are volatile compounds, which at least partially dissolve into the liquid component of the fluid.

As the concentration of these volatile compounds increases, bubbles of these compounds may be formed in the liquid component of the fluid. Once the fluid has been subjected to the ionization and energization process, the upward-flowing heated fluid will gain an additional increase in flow velocity due to the rising paths of the entrained gas bubbles, as well as the increase of temperature within the fluid. A gas-liquid separator 62 is positioned to receive the fluid and separate gas and vapor generated during the ionization and energization process. The gas and vapor flow along path 60, as indicated, to be expelled from the system. The gas and vapor may be condensed and may be further processed. An opening 64 is formed through pipe 58 for the liquid component of the fluid to pass through.

A feedback pipe 42 having an upper end and a lower end is further provided, with the upper end of feedback pipe 42 being joined to outlet pipe 58 and receiving the liquid passing through opening 64 (as indicated by flow arrows 44 in FIG. 3). The lower end of pipe 42 is joined to the lower end of the pipe 12, so that the liquid re-enters the reactor pipe 12 for further treatment, through opening 52. Flow 44 is mixed with the incoming fluid 16 in mixing zone 40, and fluid flow 16 may be user-adjusted to adjust the output gas mixture 60 to a desired set of gas components.

A heating element 46, similar to heating element 50, may be provided for pre-heating the fluid in feedback pipe 42. Heating elements 50 and 46 are in electrical communication with a temperature controller 54, which measures the temperature of the fluid within reactor pipe 12. Temperature controller 54 may be a thermostat, a thermocouple or the like and regulates the pre-heating of the fluid flows 44 and 16. Temperature controller 54 may follow pre-set programming or may be user controlled. The temperature controller 54 may further be connected to a computer, which also has, as inputs, sensors monitoring the percentages of the various desirable and undesirable components in the output mixtures coming from gas stream 60 and liquid stream 48. Further, as indicated by flow arrows 48, liquid may be extracted from feedback pipe 42 through a diverter conduit or pipe for alternative user processing.

As described above, with reference to the embodiment of FIGS. 1 and 2, in the case of removal of sulfur atoms from their bonds in large aromatic hydrocarbon molecules, ionic activity, which will also include the creation of hydrogen ions, will not only disbond some of the sulfur, but also will lead to the production of sulfur-containing gases. These gases include hydrogen sulfide, carbon disulfide, dimethyl sulfide and the like. These are removed in the output gas stream 60. Following a similar process, the heavy-metal components of a fluid hydrocarbon stream, such as vanadium, nickel and the like, will be, to some extent, disbonded from their large parent hydrocarbon molecules through the plasma activity, and will form hydride and organometallic gases, which will also be removed from gas stream 60.

System 10 may be used for the treatment of crude oil prior to delivery of the crude oil to a refinery. Based upon plasma conversion experiments using pure gaseous alkane feedstocks at the C₆ and C₁₆ level, it has been found that acetylene is one of the major products. Acetylene is a known feedstock for petrochemical factories and can be used as a substitute for ethylene. System 1 0 may further be utilized for the removal of a large percentage of sulfur from a hydrocarbon mixture. Further, system 10 may be used for the conversion of heavy crude oil into a mixture of lighter-molecular-weight hydrocarbons, thus increasing the value of the fluid.

In addition, in the embodiment of FIG. 3, the temperature of the fluid mixture can be adjusted through the selective usage of heaters 46, 50, in order for the user to control the particular gases that escape via flow 60 from the system. For example, the output temperature may be chosen to be equal to the boiling point of C₁₂. The product gases may be selected for potentially being useful for liquid fuels, petrochemical feedstocks, or both. Further, a subsequent downstream condenser stage can, for example, be set at a temperature to remove all output components heavier than C₆. In this example, a high-energy, non-aromatic-containing petroleum liquid containing C₆ to C₁₂ would be one of the outputs.

If system 10 were operated on a continuous basis, and the presence of high-fuel-value olefins and alkynes in the output mixture are desired, then the plasma converter could be utilized for converting virtually all of the input crude oil into useful lightweight and medium-weight liquid fuels. The removed hydrogen and C₁ to C₅ gases can be further used in petrochemical and other refinery applications.

Although examples have been given above involving the use of hydrocarbons with system 10, it should be understood that other elemental and compound constituents may be utilized in the input stream 16, such as chlorine, fluorine, silicon, nitrogen or any other desired substances.

It is to be understood that the present invention is not limited to the embodiments described above, but encompasses any and all embodiments within the scope of the following claims.

We claim:

1. A system for conversion of molecular weights of fluids, comprising:
an elongated reactor pipe defining a reaction chamber adapted for fluid flow of a fluid in an axial flow direction, the reactor pipe being made from an electrically conductive material and being vertically disposed, the reactor pipe having a lower end with an inlet port defined therein and having an upper end with an outlet port defined therein;
an inlet conduit connected to the inlet port for introducing the fluid into the reactor pipe for conversion of the molecular weight of compounds in the fluid;
a gas-liquid separator connected to the outlet port;
an outlet conduit connected to the gas-liquid separator for outlet of substantially gaseous output fluids after conversion in molecular weight;
a feedback pipe extending between the gas-liquid separator and the inlet conduit for recycling substantially liquid portions of the fluid through the reactor pipe for further conversion of molecular weight;
an electrode disposed within the reaction chamber and extending coaxially in the direction of fluid flow, the electrode being electrically insulated from the pipe;
a voltage source electrically connected to the reactor pipe and the electrode, the voltage source impressing opposite polarities on the reactor pipe and the electrode in order to generate a radially-extending electric field between the reactor pipe and the electrode; and
an ionizing radiation source directing ionizing radiation in the reaction chamber transverse to the direction of fluid flow, whereby the fluid flowing through the reactor pipe is at least partially ionized and energized in plasma conditions so that the molecular composition of the fluid is reformed, being converted to compounds of different molecular weight.

2. The system for conversion of molecular weights as recited in claim 1, further comprising a magnet disposed adjacent said reactor pipe and oriented to generate a magnetic field axially though the reaction chamber defined by said reactor pipe.

3. The system for conversion of molecular weights as recited in claim 1, wherein said ionizing radiation source is disposed external to said reactor pipe.

4. The system for conversion of molecular weights of fluids as recited in claim 1, wherein said ionizing radiation source is disposed internal to said electrode.

5. The system for conversion of molecular weights as recited in claim 1, further comprising a heat exchanger connected to said reactor pipe for removing and recovering heat energy generated during conversion of the molecular weights of the fluid.

6. The system for conversion of molecular weights as recited in claim 5, wherein said heat exchanger comprises a heat exchanger conduit exiting and re-entering said reactor pipe and means for extracting heat from a portion of the conduit external to said reactor pipe.

7. The system for conversion of molecular weights as recited in claim 1, further comprising a diverter conduit connected to said feedback pipe for diverting at least a portion of said liquid portion away from the reactor pipe for alternative processing.

8. The system for conversion of molecular weights as recited in claim 1, wherein said voltage source comprises a pulsed voltage source.

9. The system for conversion of molecular weights as recited in claim 1, further comprising a first heating element disposed adjacent said inlet conduit for selectively preheating of the fluid before entry into said reactor pipe.

10. The system for conversion of molecular weights as recited in claim 9, further comprising a temperature sensor for measuring temperature of fluid within the reaction chamber, the temperature sensor being in electrical communication with said first heating element and transmitting control signals thereto.

11. The system for conversion of molecular weights as recited in claim 10, further comprising a second heating element disposed adjacent said feedback pipe for heating the liquid portion therein, said second heating element being in electrical communication with said temperature sensor, said temperature sensor transmitting control signals thereto.

12. The system for conversion of molecular weights according to claim 1, wherein said ionizing radiation source comprises a source of gamma ray radiation.

13. A method for conversion of molecular weights of a fluid, comprising the steps of:
establishing an ascending flow of the fluid through a vertically disposed conduit in order to establish a fluid flow from a lower portion of the conduit through an upper portion of the conduit;
irradiating the fluid with gamma rays directed transverse to the fluid flow at an intensity and for a path length and duration of time sufficient to ionize and energize at least a portion of the fluid under plasma conditions, whereby molecular bonds are broken and the fluid is reformed and converted to compounds of different molecular weight.

14. The method for conversion of molecular weights of fluids as recited in claim 1 3, further comprising the step of generating a radially extending electric field through at least a portion of the axial length of the conduit in order to accelerate flow of electrons and ions formed by ionization of the hydrocarbon liquid.

15. The method for conversion of molecular weights according to claim 13, further comprising the step of superimposing a magnetic field axially through the conduit, whereby ions and free electrons formed in the conduit are subjected to crossed electric and magnetic fields.

16. The method for conversion of molecular weights according to claim 13, further comprising the step of extracting heat generated during converting the molecular weight through a heat exchanger.

17. The method for conversion of molecular weights according to claim 13, further comprising the step of separating gaseous and liquid compounds from the fluid flow after the irradiating step.

18. The method for conversion of molecular weights according to claim 17, further comprising the step of removing the gaseous compounds from the fluid flow.

19. The method for conversion of molecular weights according to claim 17, further comprising the step of feeding back the liquid compounds from the upper portion of the conduit to the lower portion and repeating the establishing and irradiating steps in order to further convert the molecular weight of the liquid compounds.

20. The method for conversion of molecular weights as recited in claim 13, further comprising the step of entraining a gas into the hydrocarbon liquid prior to said irradiating step in order to initiate a reaction between the gas and the hydrocarbon liquid under plasma conditions.
